(19) United States
(12) Patent Application Publication
(10) Pub. No.: US 2013/0198669 A1
(43) Pub. Date: Aug. 1, 2013

(54) SYSTEM AND METHOD FOR RESERVOIR VISUALIZATION

(71) Applicants: Zhenzhen GAO, Los Angeles, CA (US); Luciano NOCERA, Los Angeles, CA (US); Ulrich NEUMANN, Los Angeles, CA (US)

(72) Inventors: Zhenzhen GAO, Los Angeles, CA (US); Luciano NOCERA, Los Angeles, CA (US); Ulrich NEUMANN, Los Angeles, CA (US)

(73) Assignee: University of Southern California, Los Angeles, CA (US)

(21) Appl. No.: 13/739,988

(22) Filed: Jan. 11, 2013

Related U.S. Application Data
(60) Provisional application No. 61/586,386, filed on Jan. 13, 2012.

(51) Int. Cl. G06F 3/0482

(52) U.S. Cl. CPC G06F 3/0482
USPC 715/771

(57) ABSTRACT

Described herein is a data visualization system for generating an interactive 3D volume rendering of a subsurface volume with values of one or more variables displayed in the interactive 3D volume rendering of the subsurface volume.

The present application claims priority from U.S. Provisional Patent Application No. 61/586,386, filed Jan. 13, 2012, the complete disclosure of which is incorporated herein by reference in its entirety for all purposes.

### BACKGROUND

1. Field

The present disclosure relates generally to visualization of reservoir data geostatistical modeling and more particularly to use of a grammatical tool for data query and visualization.

2. Background

Reservoir data are not usually universally accessible through a unified interface. Data visualization provides users with the ability to quickly analyze and explore large amounts of disparate and potentially complex information. It is a useful component of the decision making process for the petroleum industry. Current visualization systems have widely varied interfaces and data access mechanisms that make the creation of data visualizations difficult for casual non-expert users. For instance, current systems capable of creating complex visualization use different menus, key-bindings and interactions modalities. Additionally, data is often stored in databases of different types and forms and referenced using labels that are only meaningful to database administrators. Consequently, end users that are in most need of visualizations face a daunting learning curve for both data access and data visualization.

Three dimensional rendering of complex data such as an underground petroleum reservoir may be very convenient for end users. It enables end users to be “immersed” in the rendering and directly observe the reservoir and related structures.

### SUMMARY

Described herein is a data visualization system for generating an interactive 3D volume rendering of a subsurface volume with values of one or more variables displayed in the interactive 3D volume rendering of the subsurface volume, the data visualization system comprising a computer processing system, including a display, configured to provide a user interface which: presents a plurality of selectable visualization types to the user, each selectable visualization type specifying a way in which data may be visually presented to the user, the presentation being in a format that allows the user to select at least one of the visualization types from the plurality of visualization types; receives a selection of at least one of the visualization types from the user; presents a plurality of selectable data objects to the user, each selectable data object being associated with data, the presentation being in a format that allows the user to select at least one of the data objects from the plurality of data objects; receives a selection of at least one of the data objects from the user; presents a plurality of selectable data specifications to the user, each selectable data specification specifying a portion of data within the at least one of the data objects which the user has selected, the presentation being in a format that allows the user to select at least one of the data specifications from the plurality of data specifications; receives a selection of at least one of the data specifications from the user; and displays all of the selections which the user makes of the visualization types, data objects, and data specifications as a single composite phrase; wherein the selectable visualization types comprise interactive 3D volume rendering of a subsurface volume with values of one or more variables displayed therein; and the plurality of selectable data objects comprises the one or more variables.

According to an embodiment, the computer processing system comprises a virtual reality rendering module,

According to an embodiment, the virtual reality rendering module is configured to determine spatial locations for displaying the one or more variables in the 3D volume rendering of the subsurface volume.

According to an embodiment, the spatial locations are determined based on characteristics of the one or more variables.

According to an embodiment, the virtual reality rendering module is configured to determine an initial camera location and an initial view direction.

According to an embodiment, the initial camera location and the initial view direction are determined based on the one or more variables and/or spatial locations for displaying the one or more variables.

According to an embodiment, the initial camera location is inside the 3D volume rendering of the subsurface volume.

According to an embodiment, the initial camera location is outside the 3D volume rendering of the subsurface volume.

According to an embodiment, the one or more variables are selected from a group consisting of well locations, bore locations, bore lengths, productivity of wells, age of wells, consumption rate of consumables, pressure in wells, and viscosity of well discharge.

According to an embodiment, the interactive 3D volume rendering of the subsurface volume comprises a camera control interface for receiving user input and/or is responsive to user input from a human interface device.

According to an embodiment, the data visualization system is configured to allow a user to change camera location, view direction, depth of view, and/or focal length of the interactive 3D volume rendering of the subsurface volume.

According to an embodiment, the values of the one or more variables displayed in the interactive 3D volume rendering of the subsurface volume are interactive.

According to an embodiment, the data visualization system is configured to allow a user to change the one or more variables, and/or graphic representation of the one or more variables.

According to an embodiment, the format in which the user interface presents the selectable visualization types includes a menu.

According to an embodiment, at least one of the selectable data objects is in a database which employs an access method different from a database in which at least one of the other selectable data objects resides.

According to an embodiment, the format in which the user interface presents the selectable data objects includes a menu.

According to an embodiment, the format in which the user interface presents the selectable data objects includes a map.

According to an embodiment, the format in which the user interface presents the selectable data specifications includes a menu.

According to an embodiment, the format in which the user interface presents the selectable data specifications includes a map.

According to an embodiment, the selectable data specifications include a selection of one or more fields within a record.

According to an embodiment, the selectable data specifications include a selection of one or more data filters.

According to an embodiment, the computer processing system is configured to provide a user interface which: presents a plurality of selectable data operations to the user, each selectable data operation specifying an operation which is to be performed on the portion of data which is specified by the user's selection of the at least one data specification, the presentation being in a format that allows the user to select at least one of the data operations from the plurality of data operations; receives a selection of at least one of the data operations from the user; and displays all of the selections which the user makes of the visualization types, data objects, data specifications, and data operations as a single composite selection.

According to an embodiment, the selectable data operations include one or more data aggregate functions.

According to an embodiment, the computer processing system is configured to cause the user interface to update the display one or more of subsequent selections which the user makes of the visualization types, data objects, and data specifications contemporaneously with each selection the user makes. For example, if the user selects a 2D graph as the visualization type, the computer processing system is configured to only make data objects and data specifications suitable for 2D graph available for the user to select next. Similarly if the user selects a 3D graph, the computer processing system is configured to only make data objects and data specifications suitable for 3D graph such 3D rendering available for the user to select next.

According to an embodiment, the computer processing system is configured to cause the user interface to present the visualization types, data objects, and data specifications in the order in which they are recited above.

According to an embodiment, the single composite phrase effectively communicates the selections which the user has made in conformance with the semantics of a spoken language.

According to an embodiment, the spoken language is English.

According to an embodiment, the single composite phrase conforms to the grammatical structure of the spoken language.

According to an embodiment, the computer processing system is language independent.

Also described herein is a data visualization method for allowing an untrained user to easily, rapidly, and unambiguously specify the content and format of a report about information, the data visualization method comprising making each of the presentations, receiving each of the selections, and displaying each of the selections specified in claim 1 using a user interface of a computer system having a display.

Also described herein are computer readable storage media containing computer-readable instructions configured to cause a computer system having a display to perform each of the presentations, receive each of the selections, and display each of the selections specified in some or all embodiments herein.

### DESCRIPTION OF THE DRAWINGS

Other features described herein will be more readily apparent to those skilled in the art when reading the following detailed description in connection with the accompanying drawings, wherein:

FIG. 1 is a diagram illustrating an architecture of a system in accordance with an embodiment of the disclosure;

FIG. 2 is an illustration of a menu for selecting an object from a list in accordance with an embodiment of the disclosure;

FIG. 3 is an illustration of a menu for selecting a visualization from a list of possible visualizations in accordance with an embodiment of the disclosure;

FIG. 4 is an illustration of a property panel for selecting parameters for a volume renderer in accordance with an embodiment of the disclosure;

FIGS. 5a-5f show various visualization results for a selection of wells; and

FIGS. 6a-6d show 3D volume visualizations of a reservoir.

FIG. 7A shows an exemplary scene rendered by the virtual reality renderer in response to an exemplary visualization phrase.

FIG. 7B shows an exemplary scene rendered by the virtual reality renderer in response to an exemplary visualization phrase.

FIG. 8 shows a schematic computer configured to execute any or all of the calculation described herein.

### DETAILED DESCRIPTION

A visualization grammar (VG) in accordance with an embodiment of the present disclosure may be implemented as a web-based application using SilverLight, enabling users to visualize reservoir data on a broad range of devices including workstations in the office and portable devices on the field. More particularly, in embodiments, users may utilize VG to visualize reservoir data in three dimensional (3D) renderings as will be described in more detail below. Users can construct and edit a visualization query by accessing a series of tabs that offer valid selectable data, visualization alternatives and options. Moreover, in the embodiment, VG provides a full-fledged web service layer that enables access to both traditional relational and OLAP cube databases.

In an embodiment, data field names may be remapped with labels that are meaningful to users who are not familiar with specific database architectures. Tooltips may present users with glossary information when alternatives are moused over. Finally, the front end may include a home page that handles the most popular visualization phrases integrated in the enterprise (typically as a SharePoint component). Each phrase may include information identifying a specific user responsible for that phrase, thereby allowing transparent access, identification and collaboration between users.

Embodiments may allow access to a wide range of reservoir data information including well, production, seismic, geologic and reservoir volume data. In this regard, VG may allow generation of data visualizations in the form of text, data tables, 2D plots and mixed geometry, icons, labels and reservoir volume renderings.

VG may be implemented using a three-tier architecture that supports i) data access, ii) visualization query formulation and editing and iii) visualization generation. The data access component may be an extensible service that works as a bridge between data sources and data alternatives that are presented to the user. The visualization query formulation and editing component makes use of information provided by the data access component and its own configuration. The visualization generation component may be extensible through the addition of visualization modules that are capable of turning visualization queries into graphical representations. Depending on specific software and hardware requirements, the 3D volume rendering module may be implemented as an external volume ray tracer that takes rendering commands translated from the visualization query. This architecture may allow for interface between VG and a hardware accelerated volume renderer that supports rendering of geometry embedded in a volume.

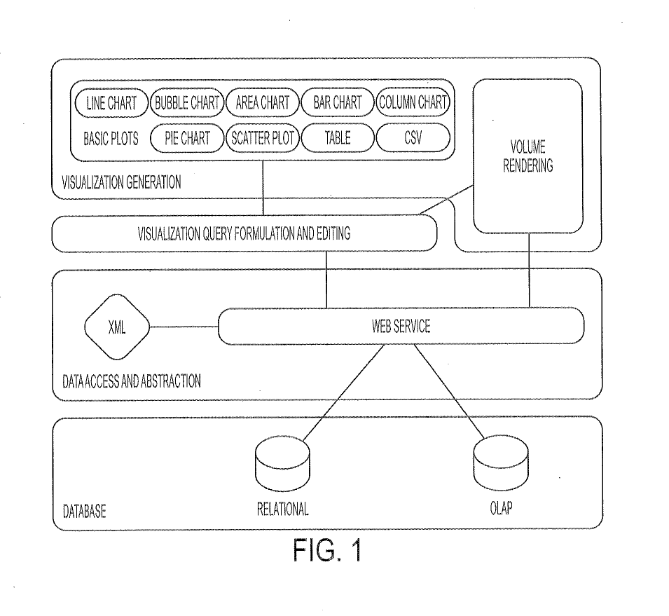

An embodiment of an architecture for VG is illustrated in FIG. 1. As shown, there are three main components providing i) data access, ii) visualization query formulation and editing and iii) visualization generation. In the embodiment, VG may communicate with external databases using the data access component and interface with external visualization tools through its visualization generation component that features visualization specific modules.

The main interface is a GUI that is adapted for communication between users and the system. The data access module works as the middle-layer between data sources and two visualization modules. On the one hand, the data access module is responsible for acquiring and processing data from its connected data sources according to a user's requests and commands; on the other hand, it is responsible for triggering visualization modules using queried results. The two visualization modules may operate independently. A basic 2D visualization module displays through GUI while a 3D visualization module displays as a separate interface that has a hidden complex UI for experts.

In an embodiment, VG's data access component may include a full-fledged web service layer that is able to interface with both relational databases and OLAP cube databases. In the embodiment, support may be provided for the database types most commonly seen in the petroleum industry; however other database types and query languages would be within the scope of the disclosure.

In an embodiment, upon the request of a visualization query, the data access component fetches the actual data from the database, dynamically filters the data and provides structural information back to the visualization query formulation component. The data filtering is useful typically for specific visualizations, for example, some graph visualizations will only accept numerical values for the ordinate axis. Consequently data type is important to decide which data are to be made available to the user in the visualization query formulation component.

A standalone implementation of VG using a SQL Server database can also perform user identification in charge of the data access component.

In operation, VG users may create visualizations interactively through the graphical user interface of the visualization query formulation component. This component may interface with the data access component to provide step by step visual guidance throughout the process of generating a phrase, i.e. the visualization query. In this approach, it is responsible for deciding what alternatives should be made available to the user based on information of data types and visualization modalities.

The visualization query formulation and editing component may be initially configured through a configuration database. The configuration database encodes information on what alternatives are available and their mappings to the database field names (so that users only see comprehensive labels instead of the meaningless actual database field names). The configuration database may also encode information on phrase building logic, for example information regarding time dependency of various alternatives. In the case of a typical relational database, it also encodes how tables are referenced and what are their primary keys. The configuration database may also store for each alternative glossary, information that is readily made available to users through tooltips. In a particular embodiment, the configuration database is stored in human readable XML format as it can be conveniently edited by hand and can be easily and automatically generated. In the case of OLAP cube databases that are rebuilt overnight, generating the configuration database automatically, it provides the flexibility to adapt to design changes of the database.

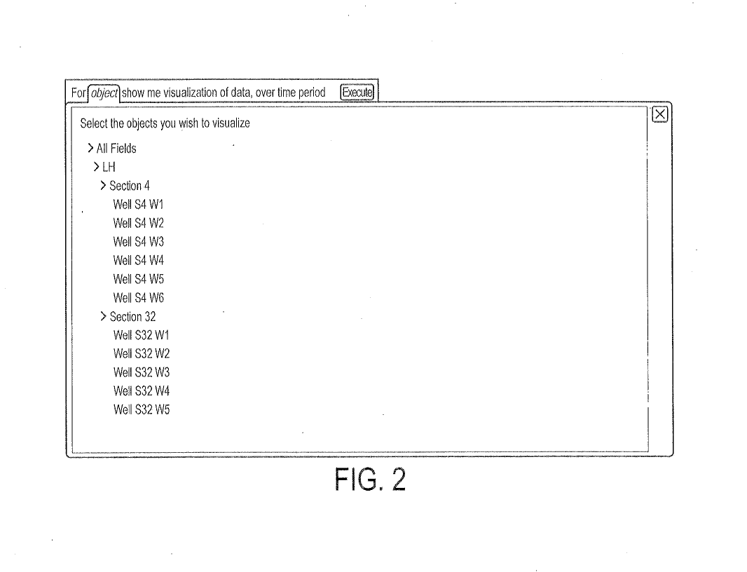

FIG. 2 shows the initial empty phrase as it appears in the user interface of VG. As illustrated in FIG. 2, the object tab may be shown in response to a user's click of “object” when the user is presented with an initial empty phrase in VG: “For object show me visualization of data, over time period.” In this example, each of the underlined words may be selected, triggering presentation of a menu from which the user may select relevant sets of data or parameters.

In the illustrated example, the interface has a consistent color scheme for terms: terms in light blue are clickable; terms in light grey are disabled and terms in orange are selected. A selected term can also be unselected. When the user clicks on a term highlighted in light blue in the phrase, a tab will appear as shown in FIG. 2. The tab offers a list of possible alternatives that the user can choose from. Phrase-building logic ensures that only valid alternatives are presented in the tab panel. When a sentence is syntactically complete, the user will be able to click the Execute button that generates the corresponding visualization.

Given the initial empty phrase: “For object show me visualization of data, over time period”, each keyword is explained in the following:

Object. Typically refers to well(s) whose data are to be visualized. The associated tab presents a hierarchical layout of wells. Users can select wells one by one, or select all wells in a hierarchy by selecting the parent node. The layout and selection mechanism are defined in the configuration database of the visualization query formulation and editing component.

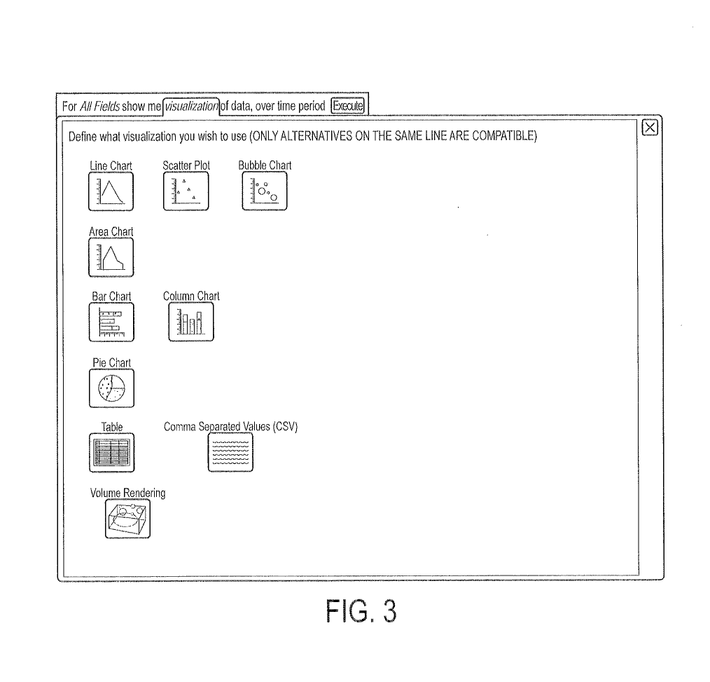

Visualization. Defines available visualization types. The associated tab contains clickable graphical icons that can be easily distinguished by visualization types. Icons of compatible visualizations are grouped together so that visualizations of the same group can be changed directly without updating other keywords of the phrase. FIG. 3 shows a number of supportable visualization types to be displayed in response to a user clicking on the term visualization in the VG phrase. Note that types on the same row are compatible with each other. The layout and compatible behavior are also defined in the configuration database.

Data. Defines the data to be visualized. The associated tab panel lists valid data given the choice of visualization type. In an embodiment, for 2D graphs the phrase will display two data fields, i.e. data_x and data_y. However, in other embodiments, the phrase may display any number of data fields. For 3D volume rendering, one data entry may be used to reference a spatial database, for example, a well name may correspond to a 3D coordinate in the spatial database. However, any number of data entries may be used to reference the spatial database.

Time period. Defines a time period for time-dependent data. The associated panel displays a calendar so that the user can conveniently select a period of time.

The visualization generation component is responsible for generating the actual visualization triggered by the execution of a phrase. This component contains modules that support each type of visualization available in VG: line chart, area chart, pie chart, scatter plot, bar chart, column chart, bubble chart, data grid, comma separated values (CSV) and volume rendering. While CSV may be implemented as simple text output, the other data are better expressed in 2D plots that may be created by, e.g., the SilverLight toolkit. The 3D volume rendering module uses a different architecture via an external renderer. Specifically, the volume rendering module first translates the visualization phrase into a list of rendering commands in XML format and stores it in a database; then the external volume renderer detects the newly written rendering commands from the database and renders the scene accordingly.

The external volume renderer can be implemented as a GPU accelerated ray tracer that is dedicated to hybrid rendering of both volumetric and polygonal data. The renderer can be integrated in VG as explained above, but it can also work independently as a standalone application with a user interface. The hardware implementation moves the complete rendering routine into GPU using OpenCL—the open standard for parallel programming of heterogeneous systems. As the ray tracer fully uses the parallel computation power of GPU, interactive frame rates are achievable.

As part of the collaborative features, users can mark an executed phrase as favorite. Favorite phrases are listed on the home page grouped in two lists: one for the current user's favorites and one for the most popular phrases of all users. Favorite phrases are ordered on popularity, i.e. the number of executions. They can be loaded and executed directly from the home page. The visualization phrases are so conveniently designed that users can share data visualizations with each other by simply copying and pasting phrases in e-mail or text document.

Improved image quality may be achieved by rendering every object in the correct depth order. Thus, polygons and volume are separately with different representations in the ray tracer. As colors from different renderable objects are composited correctly in depth, this approach provides a better depth perception.

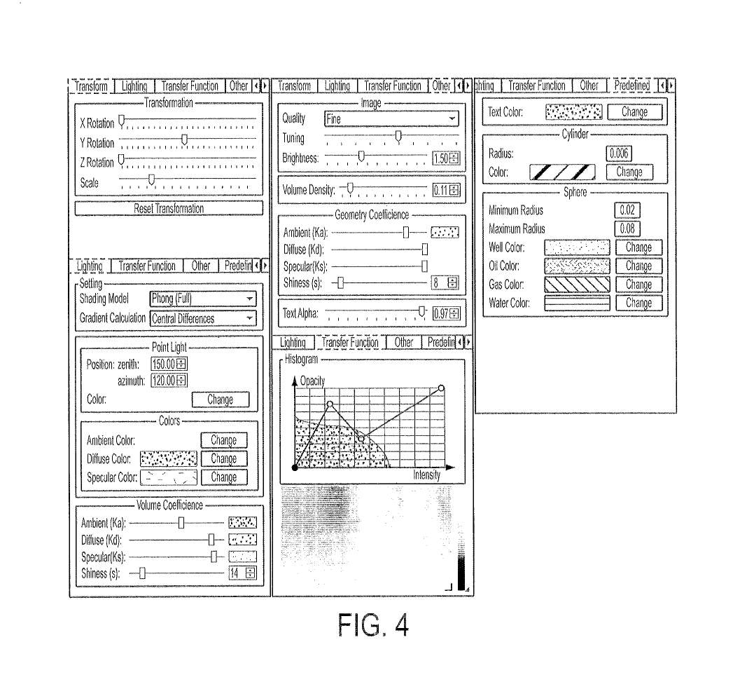

FIG. 4 illustrates a property panel for a volume renderer by which a variety of parameters may be set. Category names are highlighted by use of red rectangles in the figure.

In an embodiment, the renderer may be configured to treat various reservoir objects differently:

Top/bottom Layer Meshes. These meshes represent the top and bottom surfaces delimiting the reservoir volume being visualized. These meshes are initially in the form of line segments are transformed into a 3D volume object and rendered together with the reservoir volume; this is used to avoid rendering artifacts and the computational burden introduced by ray-line intersection tests.

Sea Level. Consists of a plane represented by a translucent flat quad and is rendered as two bluish triangles embedded in the scene.

Wells. Translucent spheres with a fixed size represent wells. Instead of triangulating the sphere and intersecting with hundreds of triangles, the simpler and more efficient ray-sphere intersection may be rendered directly.

Wellbores. Wellbores are represented as line segments. Their number is usually small so the segments may be rendered as translucent cylinders with fixed radius to provide better shading than direct line rendering.

Production Information. Translucent spheres whose sizes are adjusted dynamically symbolize production data. The sphere color is used to distinguish different kinds of production data (oil, water, gas, etc.).

In addition to the colors used for rendering objects, a number of properties can be adjusted in the volume renderer. These parameters include scene transformations, lighting properties, transfer function (used to assign color and opacity to each voxel of the reservoir volume) and image quality of the scene. Because the system is aimed at novice users, the setting interface is hidden and a default setting is applied initially. Expert users can bring up the property panel by a hotkey and save the customized parameters automatically by another hotkey. FIG. 4 provides a screenshot of the different tabs available in the UI panel of the renderer.

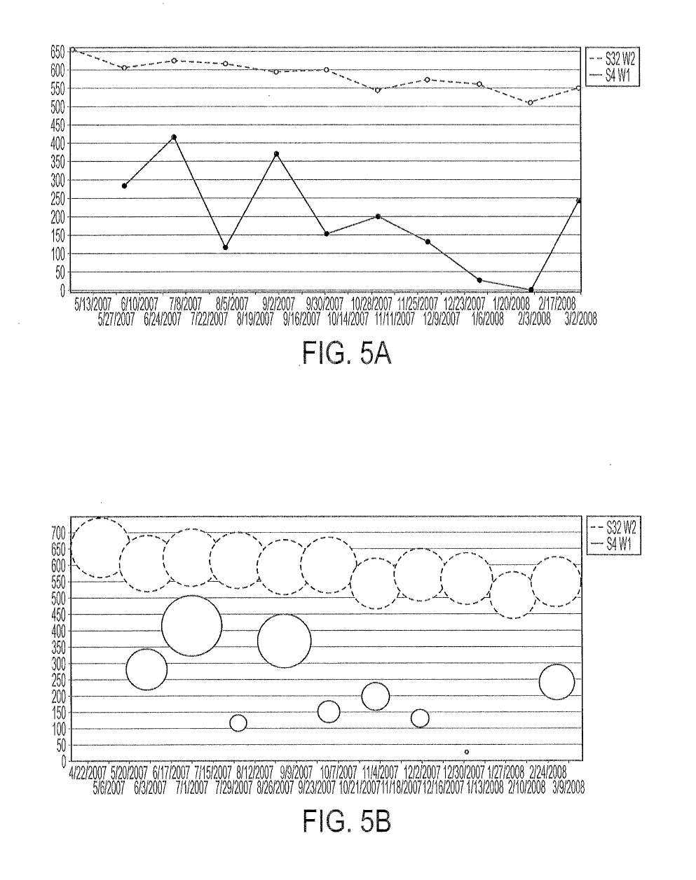

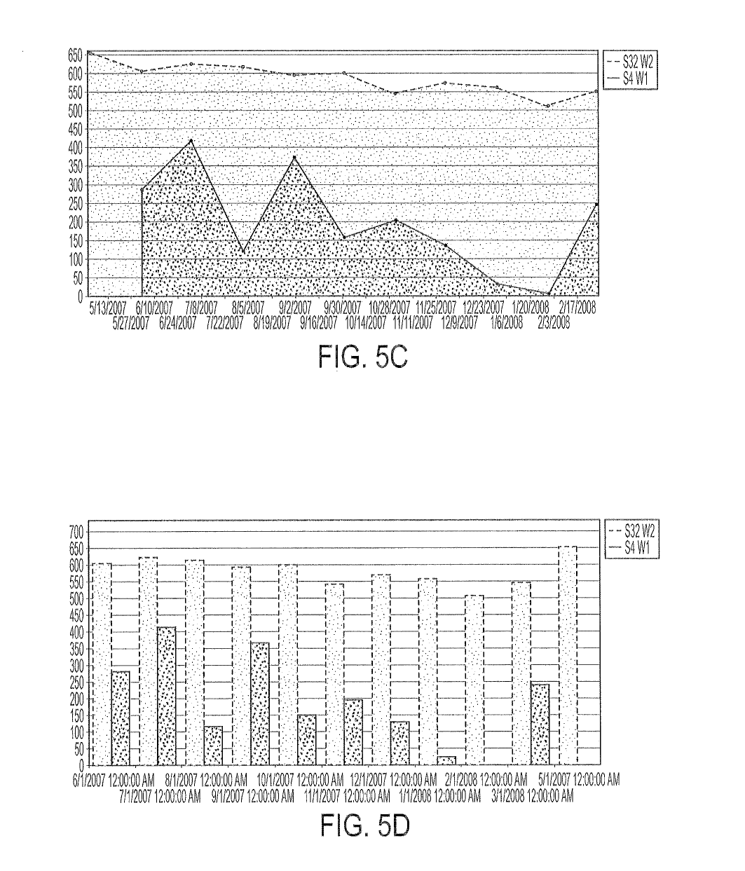

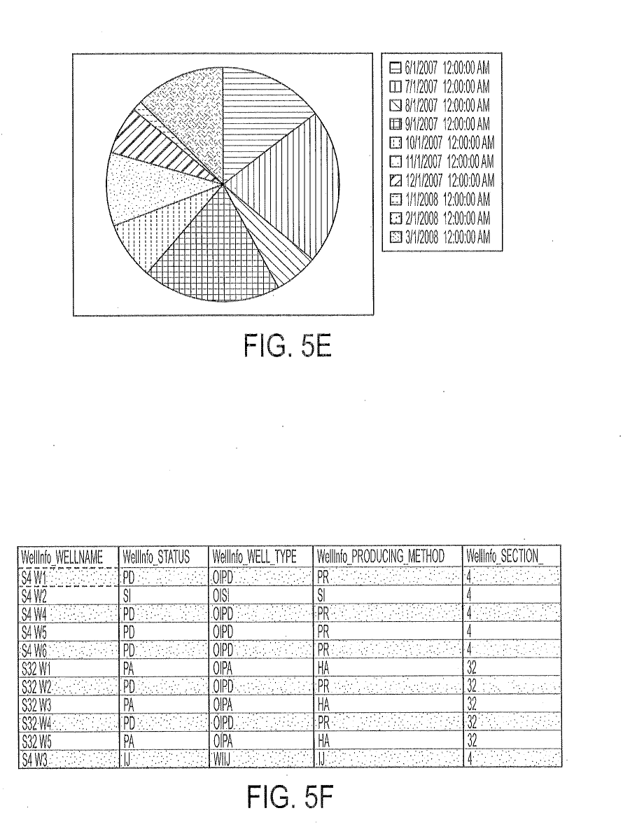

FIGS. 5a-5f show various 2D visualization results for a given selection of wells using a version on an OLAP cube database containing oil and gas production as well as well information for an actual reservoir. For the sake of demonstration, results obtained using a test relational database containing a limited data set: 2 reservoir sections and 11 wells are shown. Additionally, the test database includes geologic reservoir volume data pre-processed by geoscientists. As an example, FIG. 5a illustrates an output in response to the user query: For LH Well S4 W1, LH Well S32 W2 show me Line Chart of Oil Production as a function of Time, after Jan. 1, 2007 and before Jan. 1, 2009. FIG. 5b illustrates an output in response to the user query: For LH Well S4 W1, LH Well S32 W2 show me Bubble Chart of Oil Production as a function of Time, after Jan. 1, 2007 and before Jan. 1, 2009. FIG. 5c illustrates an output in response to the user query: For LH Well S4 W1, LH Well S32 W2 show me Area Chart of Oil Production as a function of Time, after Jan. 1, 2007 and before Jan. 1, 2009. FIG. 5d illustrates an output in response to the user query: For LH Well S4 W1, LH Well S32 W2 show me Column Chart of Oil Production as a function of Time, after 01/01/2007 and before Jan. 1, 2009. FIG. 5e illustrates an output in response to the user query; For LH Well S4 W1 show me Pie Chart of Oil Production as a function of Time, after Jan. 1, 2007 and before Jan. 1, 2009. FIG. 5f illustrates an output in response to the user query: For All Fields show me Table of Well Name, Status, Well Type, Producing Method, Section.

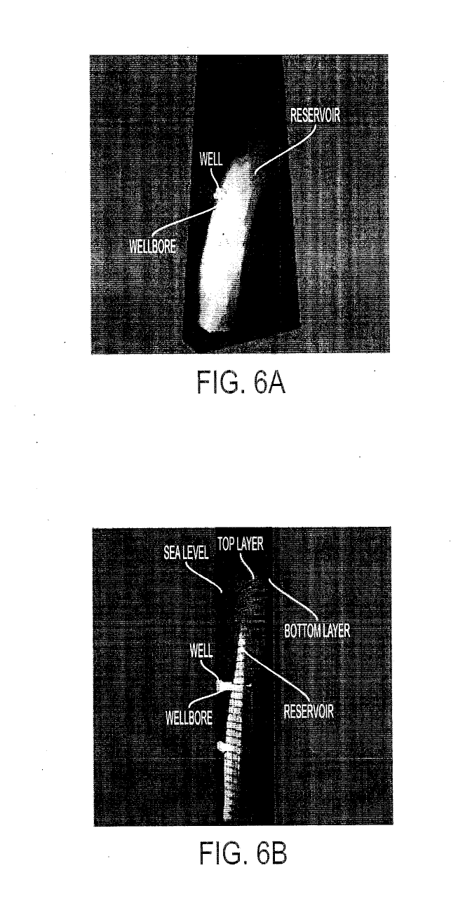

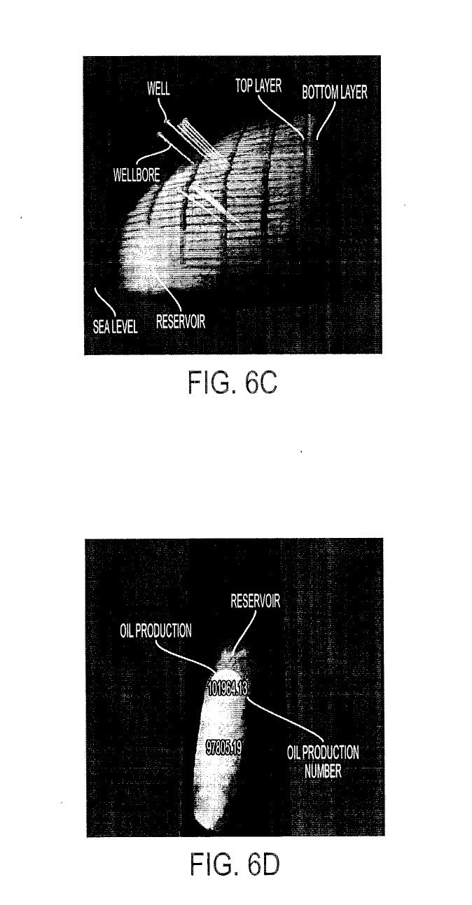

FIGS. 6a-6d present 3D volume visualization of a reservoir in which particular objects are labeled with text. FIG. 6c shows an enlarged partial view of the whole reservoir, which highlights the area around the selected wells; users can select this modality by clicking the appropriate alternative in the data tab panel.

FIG. 6a illustrates an output in response to the user query: For All Fields show me Volume Rendering of Subsurface Volume, Wellbore Mesh. FIG. 6b illustrates an output in response to the user query: For All Fields show me Volume Rendering of Subsurface Volume, Wellbore Mesh, Top Layer Mesh, Bottom Layer Mesh, Sea Level Mesh, FIG. 6c illustrates an output in response to the user query: For All Fields show me Volume Rendering of Local Subsurface Volume, Wellbore Mesh, Top Layer Mesh, Bottom Layer Mesh, Sea Level Mesh. FIG. 6d illustrates an output in response to the user query: For LH Well S4 W1, LH Well W32 S2 show me Volume Rendering of Subsurface Volume, Wellbore Mesh, Oil Production Graphic, Oil Production.

The visualization generation component may comprise a virtual reality rendering module. The virtual reality rendering module may be configured to extract variables to render as defined in the visualization phrase and to determine spatial locations for displaying the variables in a 3D volume rendering of a subsurface volume. The spatial locations may be defined in the visualization phrase or may be automatically determined according to a default setting, e.g., based on the types, values, and/or other characteristics of the variables. The virtual reality rendering module may also be configured to extract an initial camera location and an initial view direction from the visualization phrase or automatically determine an initial camera location and an initial view direction, for example, based on the variables and/or spatial locations for displaying the variables. The initial camera location may be inside the subsurface volume or outside the subsurface volume. Exemplary variables may include, without limitation, well locations, bore locations, bore lengths, productivity of wells, age of wells, consumption rate of consumables, pressure in wells, viscosity of well discharge, etc. The virtual reality rendering module may be configured to translate the information it extracted or determined from the visualization phrase into a list of rendering commands in a suitable format such as XML format and store it in a database; then an external virtual reality renderer detects these commands from the database and renders the scene accordingly, wherein the scene is interactive and can be manipulated by the users. For example, the scene may comprise a camera control interface for receiving user input and/or may be responsive to user input. The user input may change the camera location, view direction, depth of view, focal length, etc.

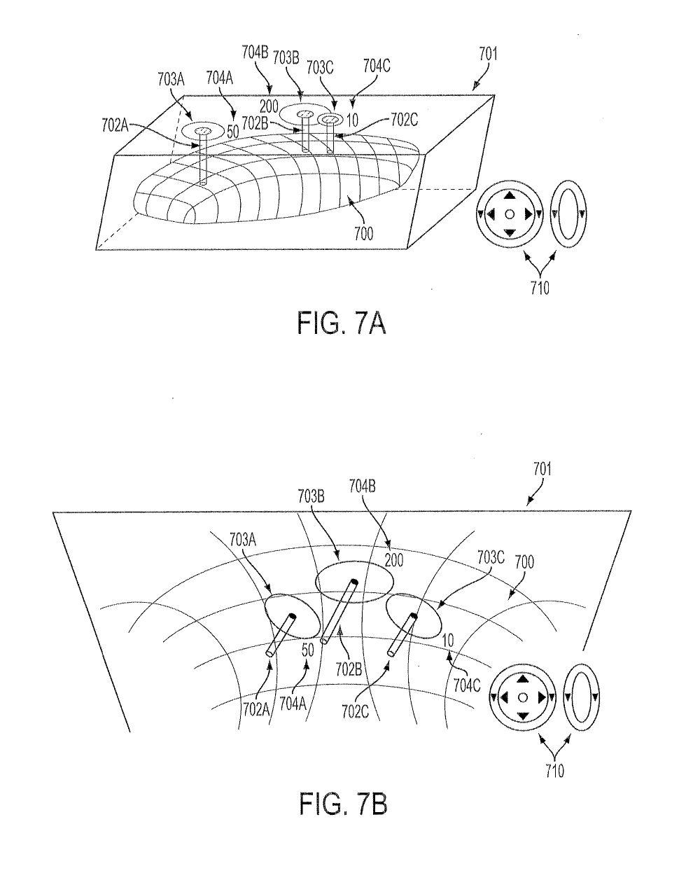

FIG. 7A shows an exemplary scene rendered by the virtual reality renderer in response to a visualization phrase For LH Well W32 S3, LH Well W32 S4, LH Well W32 S5 show me Virtual Reality Volume Rendering of Subsurface Volume, Wellbore Mesh, Oil Production. The scene comprises subsurface volume 700, sea level 701, three bore locations 702A, 702B, 702C of three wells, graphic representation of oil production 703A, 703B and 703C of each of the three wells, and numerical representation of oil production 704A, 704B and 704C of each of the three wells. The scene in FIG. 7A is rendered with an initial camera location outside the subsurface volume 700. User interface 710 may be provided to receive user input. Alternatively the scene may be responsive to user input from a human interface device such as a keyboard and/or mouse.

FIG. 7B shows an exemplary scene rendered by the virtual reality renderer in response to a visualization phrase For LH Well W32 S3, LH Well W32 S4, LH Well W32 S5 show me Virtual Reality Volume Rendering of Subsurface Volume, Wellbore Mesh, Oil Production. The scene comprises subsurface volume 700, sea level 701, three well bore locations 702A, 702B, 702C of the three wells, graphic representation of oil production 703A, 703B and 703C of each of the three wells, and numerical representation of oil production 704A, 704B and 704C of each of the three wells. The scene in FIG. 7B is rendered with an initial camera location inside the subsurface volume 700 and close to the well bores. User interface 710 may be provided to receive user input. Alternatively the scene may be responsive to user input from a human interface device such as a keyboard and/or mouse.

The variables displayed in the 3D volume rendering of the subsurface volume may also be interactive. The user may change the variable displayed, graphic representation of the variable displayed without running another visualization phrase. The virtual reality renderer may be responsive to user commands and may be capable of changing the display of the variable in real time.

Embodiments may include functionality for enhanced data manipulation, for example, allowing generalized filter options that create conditions for phrases and for applying VG in data reasoning and analytics in oil reservoir engineering and the geoscience domain. Specifically for the volume visualization module, it is within the scope of this disclosure to 1) apply traditional optimization techniques (Early Ray Termination, Empty Space Skipping, etc.) in volume rendering; 2) apply techniques such as selective super-sampling to alleviate ray tracing artifacts; 3) embed other types of objects; 4) add more features like global illumination, shadows, etc. to better visualize the volume and 5) visualize time-dependent data via animation.

More details of VG are described in U.S. Pat. No. 8,209,625, the disclosure of which is incorporated by reference in its entirety.

As will be appreciated, the method as described herein may be performed using a computing system having machine executable instructions stored on a tangible medium. The instructions are executable to perform each portion of the method, either autonomously, or with the assistance of input from an operator. In an embodiment, the system includes structures for allowing input and output of data, and a display that is configured and arranged to display the intermediate and/or final products of the process steps. A method in accordance with an embodiment may include an automated selection of a location for exploitation and/or exploratory drilling for hydrocarbon resources. Where the term processor is used, it should be understood to be applicable to multi-processor systems and/or distributed computing systems.

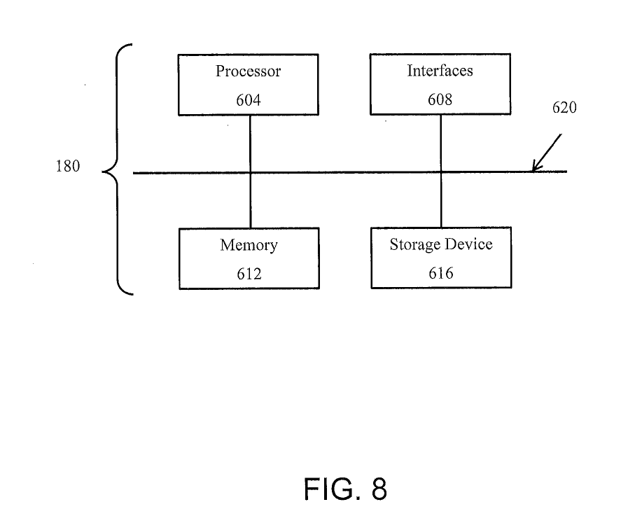

FIG. 8 illustrates a computer 180 that may comprise a general purpose computer programmed with one or more software applications that enable the various features and functions of the invention, as described in greater detail below. In one exemplary implementation, computer 180 may comprise a personal computer. Computer 180 may also comprise a portable (e.g., laptop) computer, a cell phone, smart phone, PDA, pocket PC, or other device. Computer 180 may be configured to execute any or all of the calculation in this disclosure.

Those having skill in the art will recognize that computer 180 may comprise one or more processors 604, one or more interfaces 608 (to various peripheral devices or components), memory 612, one or more storage devices 616, and/or other components coupled via a bus 620. Memory 612 may comprise random access memory (RAM), read only memory (ROM), or other memory. Memory 612 may store computer-executable instructions to be executed by one or more processors 604 as well as data which may be manipulated by the one or more processors 604. Storage devices 616 may comprise floppy disks, hard disks, optical disks, tapes, or other storage devices for storing computer-executable instructions and/or data. One or more software applications may be loaded into memory 612 and run on an operating system of computer 180. In some implementations, an Application Program Interface (API) may be provided to, for example, enable third-party developers to create complimentary applications, and/or to enable content exchange.

Those skilled in the art will appreciate that the disclosed embodiments described herein are by way of example only, and that numerous variations will exist. The disclosure is limited only by the claims, which encompass the embodiments described herein as well as variants apparent to those skilled in the art. In addition, it should be appreciated that structural features or method steps shown or described in any one embodiment herein can be used in other embodiments as well.

1. A data visualization system for generating an interactive 3D volume rendering of a subsurface volume with values of one or more variables displayed in the interactive 3D volume rendering of the subsurface volume, the data visualization system comprising
a computer processing system, including a display, configured to provide a user interface which:
presents a plurality of selectable visualization types to the user, each selectable visualization type specifying a way in which data may be visually presented to the user, the presentation being in a format that allows the user to select at least one of the visualization types from the plurality of visualization types;
receives a selection of at least one of the visualization types from the user;
presents a plurality of selectable data objects to the user, each selectable data object being associated with data, the presentation being in a format that allows the user to select at least one of the data objects from the plurality of data objects;
receives a selection of at least one of the data objects from the user;
presents a plurality of selectable data specifications to the user, each selectable data specification specifying a portion of data within the at least one of the data objects which the user has selected, the presentation being in a format that allows the user to select at least one of the data specifications from the plurality of data specifications;
receives a selection of at least one of the data specifications from the user; and
displays all of the selections which the user makes of the visualization types, data objects, and data specifications as a single composite phrase;
wherein the selectable visualization types comprise at least one interactive 3D volume rendering of a subsurface volume with values of one or more variables displayed therein; and the plurality of selectable data objects comprises the one or more variables.

2. The data visualization system of claim 1, wherein the computer processing system comprises a virtual reality rendering module.

3. The data visualization system of claim 2, wherein the virtual reality rendering module is configured to determine spatial locations for displaying the one or more variables in the 3D volume rendering of the subsurface volume.

4. The data visualization system of claim 3, wherein the spatial locations are determined based on characteristics of the one or more variables.

5. The data visualization system of claim 2, wherein the virtual reality rendering module is configured to determine an initial camera location and an initial view direction.

6. The data visualization system of claim 5, wherein the initial camera location and the initial view direction are determined based on the one or more variables and/or spatial locations for displaying the one or more variables.

7. The data visualization system of claim 5, wherein the initial camera location is inside the 3D volume rendering of the subsurface volume.

8. The data visualization system of claim 5, wherein the initial camera location is outside the 3D volume rendering of the subsurface volume.

9. The data visualization system of claim 1, wherein the one or more variables are selected from a group consisting of well locations, bore locations, bore lengths, productivity of wells, age of wells, consumption rate of consumables, pressure in wells, and viscosity of well discharge.

10. The data visualization system of claim 1, wherein the interactive 3D volume rendering of the subsurface volume comprises a camera control interface for receiving user input and/or is responsive to user input from a human interface device.

11. The data visualization system of claim 1, wherein the data visualization system is configured to allow a user to change camera location, view direction, depth of view, and/or focal length of the interactive 3D volume rendering of the subsurface volume.

12. The data visualization system of claim 1, wherein the values of the one or more variables displayed in the interactive 3D volume rendering of the subsurface volume are interactive.

13. The data visualization system of claim 13, wherein the data visualization system is configured to allow a user to change the one or more variables, and/or graphic representation of the one or more variables.

14. The data visualization system of claim 1 wherein the format in which the user interface presents the selectable visualization types includes a menu.

15. The data visualization system of claim 1 wherein at least one of the selectable data objects is in a database which employs an access method different from a database in which at least one of the other selectable data objects resides.

16. The data visualization system of claim 1 wherein the format in which the user interface presents the selectable data objects includes a menu.

17. The data visualization system of claim 1 wherein the format in which the user interface presents the selectable data objects includes a map.

18. The data visualization system of claim 1 wherein the format in which the user interface presents the selectable data specifications includes a menu.

19. The data visualization system of claim 1 wherein the format in which the user interface presents the selectable data specifications includes a map.

20. The data visualization system of claim 1 wherein the selectable data specifications include a selection of one or more fields within a record.

21. The data visualization system of claim 1 wherein the selectable data specifications include a selection of one or more data filters.

22. The data visualization system of claim 1 wherein the computer processing system is configured to provide a user interface which: presents a plurality of selectable data operations to the user, each selectable data operation specifying an operation which is to be performed on the portion of data which is specified by the user's selection of the at least one data specification, the presentation being in a format that allows the user to select at least one of the data operations from the plurality of data operations; receives a selection of at least one of the data operations from the user; and displays all of the selections which the user makes of the visualization types, data objects, data specifications, and data operations as a single composite selection.

23. The data visualization system of claim 22 wherein the selectable data operations include one or more data aggregate functions.

24. The data visualization system of claim 1 wherein the computer processing system is configured to cause the user interface to update the display all of the selections which the user makes of the visualization types, data objects, and data specifications contemporaneously with each selection the user makes.

25. The data visualization system of claim 1 wherein the computer processing system is configured to cause the user interface to present the visualization types, data objects, and data specifications in the order in which they are recited in claim 1.

26. The data visualization system of claim 1 wherein the single composite phrase effectively communicates the selections which the user has made in conformance with the semantics of a spoken language.

27. The data visualization system of claim 26 in which the spoken language is English.

28. The data visualization system of claim 26 in which the single composite phrase conforms to the grammatical structure of the spoken language.

29. The data visualization system of claim 1, wherein the computer processing system is configured to store the single composite phrase as a favorite phrase.

30. The data visualization system of claim 29, wherein the favorite phrase is stored in a first list accessible only to one or more specific users.

31. The data visualization system of claim 29, wherein the favorite phrase is stored in a second list accessible to all users.

32. The data visualization system of claim 30, wherein favorite phrases stored in the first list is ordered by a number of execution of the favorite phrases therein.

33. The data visualization system of claim 31, wherein favorite phrases stored in the first list is ordered by a number of execution of the favorite phrases therein.

34. A data visualization method for allowing an untrained user to easily, rapidly, and unambiguously specify the content and format of a report about information, the data visualization method comprising making each of the presentations, receiving each of the selections, and displaying each of the selections specified in claim 1 using a user interface of a computer system having a display.

35. Computer readable storage media containing computer-readable instructions configured to cause a computer system having a display to perform each of the presentations, receive each of the selections, and display each of the selections specified in claim 1.
